(19) United States
(12) Patent Application Publication
(10) Pub. No.: US 2026/0056111 A1
(43) Pub. Date: Feb. 26, 2026

(54) SYSTEM AND METHOD FOR MONITORING PARTICLES OF APPARATUS

(71) Applicant: SEMES CO., LTD., Cheonan-si (KR)

(72) Inventor: Kyung Taek IM, Cheonan-si (KR)

(21) Appl. No.: 19/255,980

(22) Filed: Jun. 30, 2025

(30) Foreign Application Priority Data
Aug. 26, 2024 (KR) 10-2024-0114090

(51) Int. Cl. G01N 15/14; G01N 1/20; G01N 15/10

(52) U.S. Cl. CPC G01N 15/14; G01N 1/2035; G01N 2001/205; G01N 2015/1024; G01N 2015/1486

(57) ABSTRACT

A system for monitoring particles of an apparatus includes a particle counter configured to measure the number of particles in a gas sample obtained from an apparatus; a manifold unit configured to provide a flow path for the gas sample to move from the apparatus to the particle counter; a valve unit including a plurality of valves installed in different positions in the manifold unit; and a control unit configured to control opening and closing of the plurality of valves, wherein the manifold unit includes a plurality of manifolds having a hierarchical structure and installed between the particle counter and a plurality of measurement points of the apparatus.

### CROSS-REFERENCE TO RELATED APPLICATION(S)

This application claims benefit of priority to Korean Patent Application No. 10-2024-0114090 filed on Aug. 26, 2024 in the Korean Intellectual Property Office, the disclosure of which is incorporated herein by reference in its entirety.

### BACKGROUND

### 1. Field

The present disclosure relates to a system and a method for monitoring particles of an apparatus.

### 2. Description of Related Art

A semiconductor manufacturing process may be performed in a clean room maintaining high cleanliness and may include various processes such as photo, etching, deposition, and cleaning processes. The photolithography process may be to form a desired resist pattern by applying a resist solution to a substrate and exposing and developing using a photolithography mask, and may include a resist solution application process, and an exposure and development process.

A semiconductor manufacturing apparatus may generally have a plurality of individual process chambers having internal spaces for processing each process, and may also have a transfer space for transporting a substrate internally and externally of an apparatus or between chambers.

Process efficiency may be reduced and an apparatus may malfunction due to particles or process byproducts generated during the process of performing each process, and thus, it may be necessary to monitor and manage the particle level for each space.

Generally, to manage the particle level in various spaces of an apparatus, it may be necessary to install a plurality of monitoring apparatuses in each space.

Accordingly, complexity and costs of the apparatus may increase, and spatial efficiency may be reduced.

### SUMMARY

An embodiment of the present disclosure is to provide a system and a method for monitoring particles of an apparatus, which may monitor particle levels of a plurality of measurement points of an apparatus.

An embodiment of the present disclosure is to provide a system and a method for monitoring particles of an apparatus, which may obtain a gas sample at a desired measurement point by controlling a plurality of manifolds having a hierarchical structure and opening and closing of a plurality of valves installed in different positions in the manifolds.

An embodiment of the present disclosure is to provide a system and a method for monitoring particles of an apparatus, which may control opening and closing of a plurality of valves based on a predetermined sequence such that gas samples of a plurality of measurement points may flow in sequentially, or such that gas samples of a specific portion of the plurality of measurement points may flow in.

An embodiment of the present disclosure provides a system and a method for monitoring particles of an apparatus as below.

According to an embodiment of the present disclosure, a system for monitoring particles of an apparatus includes a particle counter configured to measure the number of particles in a gas sample obtained from an apparatus; a manifold unit configured to provide a flow path for the gas sample to move from the apparatus to the particle counter; a valve unit including a plurality of valves installed in different positions in the manifold unit; and a control unit configured to control opening and closing of the plurality of valves, wherein the manifold unit includes a plurality of manifolds having a hierarchical structure and installed between the particle counter and a plurality of measurement points of the apparatus.

According to an embodiment of the present disclosure, a method for monitoring particles of an apparatus includes configuring a particle measurement sequence of an apparatus; controlling opening and closing of a plurality of valves based on the particle measurement sequence; and measuring the number of particles in a gas sample flowing in from one or more measurement points of the apparatus, wherein the plurality of valves are installed in different positions in a manifold unit configured to provide a flow path for the gas sample to move from the apparatus to a particle counter configured to measure the number of particles, and wherein the manifold unit includes a plurality of manifolds having a hierarchical structure and installed between the particle counter and a plurality of measurement points of the apparatus.

According to an embodiment of the present disclosure, a system for monitoring particles of an apparatus includes a particle counter configured to measure the number of particles in a gas sample obtained from the apparatus; a manifold unit configured to provide a flow path for the gas sample to move from the apparatus to the particle counter; a valve unit including a plurality of valves installed in different positions in the manifold unit; a flow rate sensor configured to measure a flow rate in the manifold unit; and a control unit configured to individually control opening and closing of the plurality of valves, wherein the apparatus is divided into a plurality of levels including one or more measurement points, and wherein the manifold unit includes an upper manifold connecting the particle counter to the apparatus; and a lower manifold installed on one of the plurality of levels and connecting the upper manifold to one or more measurement points positioned in the one of the levels, wherein the valve unit includes a plurality of first valves installed on the upper manifold; and a plurality of second valves installed on the lower manifold.

### BRIEF DESCRIPTION OF DRAWINGS

The and other aspects, features, and advantages of the present disclosure will be more clearly understood from the following detailed description, taken in combination with the accompanying drawings, in which:

FIG. 1 is a block diagram illustrating a system for monitoring particles according to an embodiment of the present disclosure;

FIG. 2 is a diagram illustrating a system for monitoring particles and an apparatus according to an embodiment of the present disclosure;

FIG. 3A is a diagram illustrating a system for monitoring particles and a portion of an apparatus according to an embodiment of the present disclosure;

FIG. 3B is a diagram illustrating a system for monitoring particles and a portion of an apparatus according to an embodiment of the present disclosure;

FIG. 3C is a diagram illustrating a system for monitoring particles and a portion of an apparatus according to an embodiment of the present disclosure;

FIG. 4 is a diagram illustrating a system for monitoring particles and apparatus according to another embodiment of the present disclosure;

FIG. 5 is a flowchart illustrating a method for monitoring particles according to another embodiment of the present disclosure; and

FIG. 6 is a block diagram illustrating a computing apparatus in which a method for monitoring particles according to an embodiment may be implemented entirely or partially.

### DETAILED DESCRIPTION

Hereinafter, embodiments of the present disclosure will be described as below with reference to the accompanying drawings.

The present disclosure is not limited to exemplary embodiments, and it is to be understood that various modifications may be made without departing from the spirit and scope of the present disclosure.

Also, descriptions of functions and constructions that are well known to one of ordinary skill in the art may be omitted for increased clarity and conciseness.

In the accompanying drawings, some elements may be exaggerated, omitted or briefly illustrated, and the sizes of the elements do not necessarily reflect the actual sizes of these elements.

Also, redundant descriptions and detailed descriptions of known functions and elements which may unnecessarily render the gist of the present disclosure obscure will be omitted. The terms described below are defined in consideration of functions thereof in the present disclosure, and may vary depending on the intention or custom of a user or operator. Accordingly, the definitions thereof should be based on the descriptions throughout this specification. Terms used in the present specification are for explaining the embodiments rather than limiting the present invention. Unless explicitly described to the contrary, a singular form includes a plural form in the present specification.

The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the embodiments, the term “connected” may not only refer to “directly connected” but also include “indirectly connected” with another component interposed therebetween. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

It should be noted that embodiments or examples described in this specification is not limited to a single embodiment or example, and may be combined with other embodiments or examples. Accordingly, the patent claims is only an example of an embodiment, and the technical idea of the present disclosure should not be interpreted merely as a combination with the claim, and the combination with various claims is also included in the scope of the technical idea of the present disclosure.

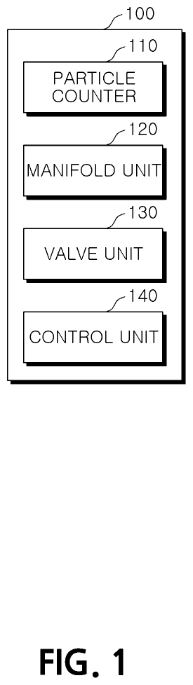

FIG. 1 is a block diagram illustrating a system for monitoring particles according to an embodiment.

The system 100 for monitoring particles may be configured to monitor particle levels in different positions of the apparatus 10. The apparatus 10 may be implemented as, for example, a semiconductor manufacturing apparatus including a plurality of levels. In addition to the semiconductor manufacturing apparatus, the apparatus 10 may be configured as an apparatus having a large size or an internal region divided into a plurality of regions.

Using the system 100 for monitoring particles according to an embodiment, particle levels of multiple measurement points may be managed and monitored in an integrated manner using a particle counter without separately installing particle counters at multiple measurement points of the apparatus 10 for which particle levels are to be monitored.

Referring to FIG. 1, the system 100 for monitoring particles may include a particle counter 110, a manifold unit 120, a valve unit 130, and a control unit 140.

The particle counter 110 may be configured as an apparatus configured to measure the number of particles in a gas sample. For example, the particle counter 110 may irradiate a laser beam to a gas sample and may measure the number of particles in the gas sample based on the degree of scattering of the laser beam.

The particle counter 110 may measure the number of particles in the gas sample obtained from the apparatus 10. The gas sample may be obtained from a space positioned internally or externally of the apparatus 10.

The gas sample may be obtained from an internal space of a chamber in which processing of a semiconductor substrate is performed or a transport space in which transport of a semiconductor substrate is performed, for example.

The apparatus 10 may be divided into a plurality of levels. Each level of the apparatus 10 may include one or more measurement points. The one or more measurement points may be positioned in one of a baking unit, a coating unit, a developing unit, or a substrate transport space by a mobile robot of a photolithography apparatus, for example.

The manifold unit 120 may be installed between the particle counter 110 and one or more measurement points of the apparatus 10. The manifold unit 120 may provide a flow path for a gas sample to move from the apparatus 10 to the particle counter 110.

That is, the manifold unit 120 may provide a flow path for a gas sample to move from one or more measurement points of the apparatus 10 to the particle counter 110.

The manifold unit 120 may include a plurality of manifolds having a hierarchical structure.

For example, the manifold unit may include a manifold A1 and a manifold A2. The manifold A2 may be on a lower level connected to the downstream side of the manifold A1. In this case, the manifold unit may have a hierarchical structure of manifold A1-manifold A2.

For another example, the manifold unit may include a manifold B1, a manifold B2 and a manifold B3. The manifold B2 may be on a lower level connected to the downstream side of the manifold B1. The manifold B3 may be on a lower level connected to the downstream side of the manifold B2. In this case, the manifold unit may have a hierarchical structure of manifold B1-manifold B2-manifold B3.

For another example, the manifold unit may include a manifold C1, a manifold C2 and a manifold C3. The manifold C2 may be on a lower level connected to the downstream side of the manifold C1. The manifold C3 may be on a lower level connected to the downstream side of the manifold C1. In this case, the manifold unit may have a hierarchical structure of manifold C1-manifold C2 and manifold C3.

That is, in the hierarchical structure in which a plurality of manifolds are connected to each other, the number of manifolds included in the same level may be one or more.

The plurality of manifolds may include a body member, an upper-level connection member, and a plurality of lower-level connection members.

The body member may provide a moving space for gas flowing in from the plurality of lower-level connection members to move to the upper-level connection member.

The upper-level connection member may be connected to the body member such that one end of the upper-level connection member may be connected to an internal space of the body member. The upper-level connection member may extend in the upstream direction from the body member toward the particle counter.

The plurality of lower-level connection members may be connected to the body member such that one end of the lower-level connection members may be connected to an internal space of the body member. The plurality of lower-level connection members may extend in the downstream direction from the body member toward an apparatus or a plurality of measurement points.

The valve unit 130 may include a plurality of valves installed in different positions in the manifold unit 120. The plurality of valves may open a flow path to allow gas to move in a portion of the manifold unit 120, or may close a flow path to prevent gas from moving in a portion of the manifold unit 120.

The plurality of valves may be installed in the upper-level connection member of the plurality of the manifold or the plurality of lower-level connection members.

The control unit 140 may control opening and closing of the plurality of valves. The control unit 140 may individually control opening and closing of the plurality of valves through wired or wireless communication.

The control unit 140 may change the gas sample transferred to the particle counter 110 by controlling opening and closing of the plurality of valves.

The control unit 140 may control opening and closing of the plurality of valves based on a predetermined sequence. The sequence may be configured such that gas samples at one or more measurement points of the apparatus 10 may flow sequentially into the particle counter 110.

Also, when the plurality of measurement points of the apparatus 10 are grouped into a plurality of measurement groups, the sequence may be configured such that gas samples of the plurality of measurement groups may flow sequentially into the particle counter 110.

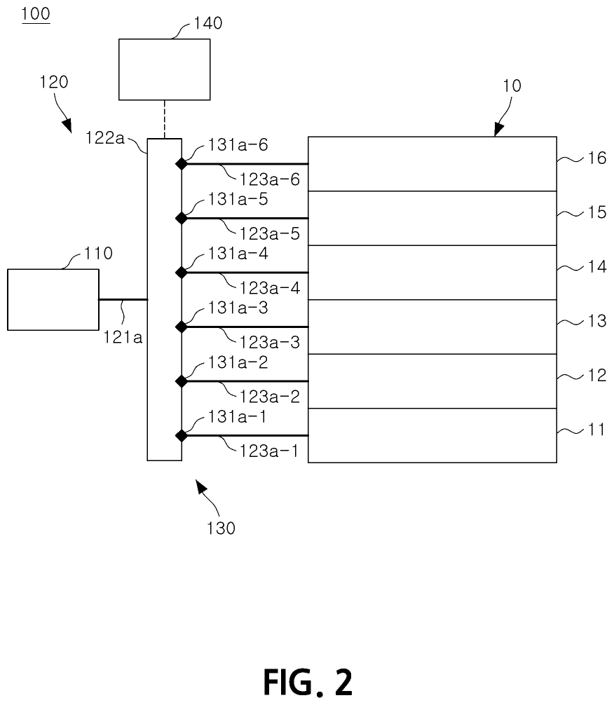

FIG. 2 is a diagram illustrating a system 100 for monitoring particles and an apparatus 10 according to an embodiment.

Referring to FIG. 2, the apparatus 10 may be divided into a plurality of levels 11 to 16. Each level of the apparatus 10 may include one or more measurement points. For example, the sixth level 16 of the apparatus 10 may include a plurality of measurement points having different positions, and the fifth level 15 of the apparatus 10 may include a plurality of measurement points having different positions.

FIG. 2 illustrates the example in which the apparatus 10 is divided into six levels, but this is merely an example of the apparatus 10, and the apparatus 10 may be divided into six or more levels or six or less levels.

As illustrated in FIG. 2, the system 100 for monitoring particles may include a particle counter 110, a manifold unit 120, a valve unit 130, and a control unit 140.

The manifold unit 120 may include a first manifold connected between the particle counter 110 and the plurality of levels of the apparatus 10.

The first manifold may include a first body member 122a, a first upper-level connection member 121a, and a plurality of first lower-level connection members 123a-1 to 123a-6.

The first body member 122a may provide a moving space for gas flowing in from the plurality of first lower-level connection members 123a-1 to 123a-6 to move to the first upper-level connection member 121a.

The first upper-level connection member 121a may be connected to the first body member 122a such that one end of the first upper-level connection member 121a may be connected to an internal space of the first body member 122a. The first upper-level connection member 121a may extend in the upstream direction from the first body member 122a toward the particle counter 110.

The plurality of first lower-level connection members 123a-1 to 123a-6 may be connected to the first body member 122a such that one end of the first lower-level connection members may be connected to the internal space of the first body member 122a. The plurality of first lower-level connection members 123a-1 to 123a-6 may extend in the downstream direction from the first body member 122a toward each level of the apparatus 10.

The plurality of valves 131a-1 to 131a-6 may be installed in the plurality of first lower-level connection members 123a-1 to 123a-6.

In the example illustrated in FIG. 2, the plurality of valves 131a-1 to 131a-6 may be installed in a region close to the first body member 122a of the plurality of first lower-level connection members 123a-1 to 123a-6, but the plurality of valves 131a-1 to 131a-6 may also be installed in a region close to a central portion or another end of the plurality of first lower-level connection members 123a-1 to 123a-6.

By controlling opening and closing of the plurality of valves 131a-1 to 131a-6, an obtained position of a gas sample flowing in from one of the plurality of levels 11 to 16 of the apparatus 10 through the first manifold to the particle counter 110 may be changed.

The manifold unit 120 may further include a second manifold connected between the first manifold and one or more measurement points.

The second manifold may be connected between, for example, one of the plurality of first lower-level connection members 123a-1 to 123a-6 of the first manifold and one or more measurement points included in one of the plurality of levels of the apparatus 10.

The one or more measurement points may be positioned, for example, in a bake unit, a coating unit, a developing unit, or a substrate transport space by a mobile robot of a photolithography apparatus.

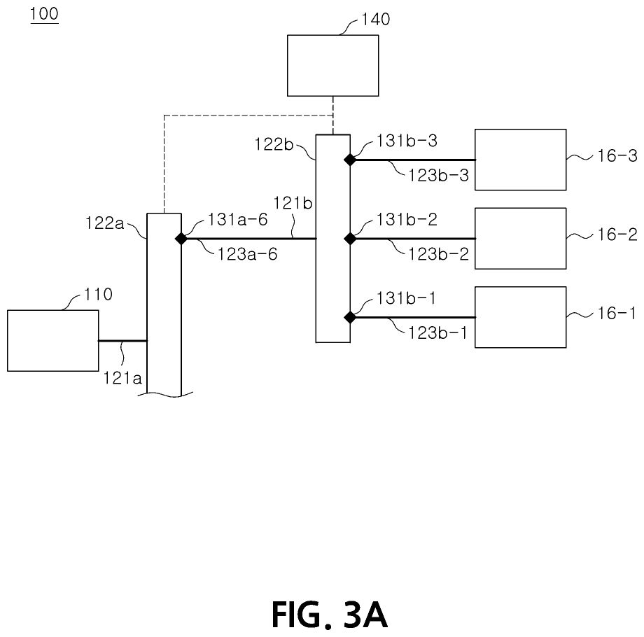

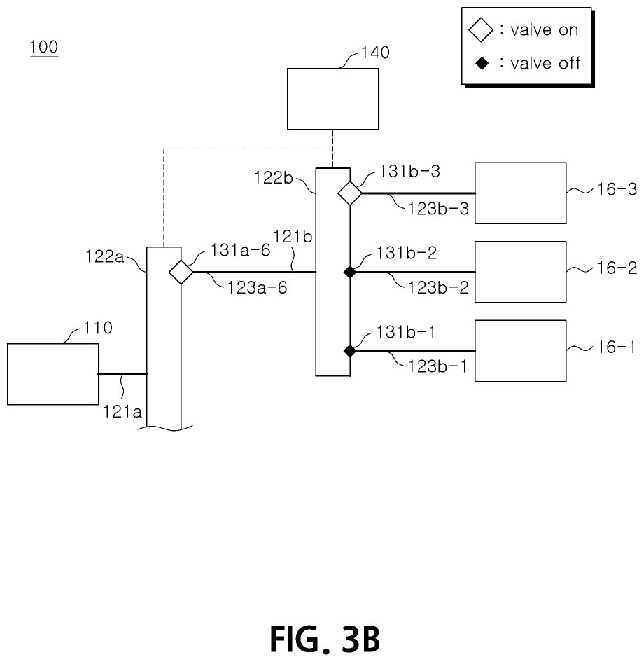

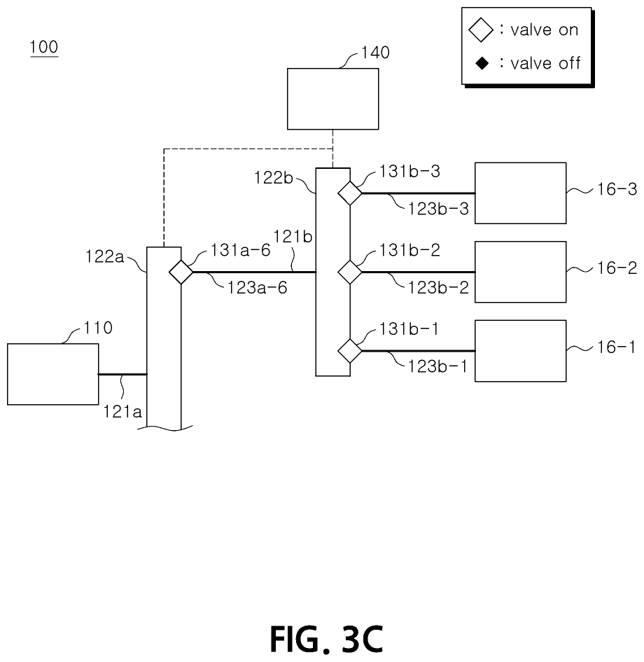

FIG. 3A is a diagram illustrating a system 100 for monitoring particles and a portion of an apparatus 10 according to an embodiment, illustrating a second manifold connected to a first lower-level connection member 123a-6 for the sixth level 16 of the apparatus 10 among the plurality of first lower-level connection members 123a-1 to 123a-6 of the first manifold illustrated in FIG. 2.

The sixth level 16 of the apparatus 10 may include a plurality of measurement points 16-1 to 16-3 disposed in different positions.

As illustrated in FIGS. 3A to 3C, the second manifold may include a second body member 122b, a second upper-level connection member 121b, and a plurality of second lower-level connection members 123b-1 to 123b-3.

The second body member 122b may provide a moving space for gas flowing in from the plurality of second lower-level connection members 123b-1 to 123b-3 to move to the second upper-level connection member 121b.

The second upper-level connection member 121b may be connected to the second body member 122b such that one end thereof may be connected to an internal space of the second body member 122b. The second upper-level connection member 121b may extend in the upstream direction from the second body member 122b toward the first lower-level connection member 123a-6 of the first manifold. Another end of the second upper-level connection member 121b may be connected to the first lower-level connection member 123a-6 of the first manifold.

The plurality of second lower-level connection members 123b-1 to 123b-3 may be connected to the second body member 122b such that one end may be connected to the internal space of the second body member 122b. The plurality of second lower-level connection members 123b-1 to 123b-3 may extend in the downstream direction from the second body member 122b toward the plurality of measurement points 16-1 to 16-3 of the apparatus 10.

A plurality of valves 131a-6 and 131b-1 to 131b-3 may be installed in the first lower-level connection member 123a-6 or the plurality of second lower-level connection members 123b-1 to 123b-3.

In the example illustrated in FIGS. 3A to 3C, the valve 131a-6 may be installed in the first lower-level connection member 123a-6 of the first manifold, or the valve 131a-6 may also be installed in the second upper-level connection member 121b of the second manifold.

Also, the plurality of valves 131a-1 to 131a-6 may be installed in a region close to the first body member 122a of the plurality of first lower-level connection members 123a-1 to 123a-6, or the plurality of valves 131a-1 to 131a-6 may also be installed in a region close to a central portion or another end of the plurality of first lower-level connection members 123a-1 to 123a-6.

By controlling opening and closing of the plurality of valves 131a-6 and 131b-1 to 131b-3, an obtained position of a gas sample flowing in from one of the plurality of measurement points 16-1 to 16-3 of the apparatus 10 through the first manifold and the second manifold to the particle counter 110 may be changed.

FIG. 3B may illustrate a state in which the valve 131a-6 and the valve 131b-3 are open, and the valve 131b-1 and the valve 131b-2 are closed. When opening and closing of the valve are controlled as in FIG. 3B, the gas sample obtained from the measurement point 16-3 may be transferred to the particle counter 110. The gas samples of other measurement points 16-1 and 16-2 may not be transferred to the particle counter 110.

FIG. 3C may illustrate a state in which the plurality of valves 131a-6 and 131b-1 to 131b-3 are open. When opening and closing of the valve are controlled as in FIG. 3C, the gas samples obtained from the plurality of measurement points 16-1 to 16-3 may be transferred to the particle counter 110.

One or more measurement points of the apparatus 10 may be grouped into one or more regions.

For example, one or more measurement points of the apparatus 10 may be grouped based on the degree of proximity between the measurement points.

The manifold unit 120 may further include a third manifold connected between the second manifold and one or more regions grouped based on the degree of proximity to each other. The third manifold may include a third body member, a third upper-level connection member, and a plurality of third lower-level connection members, similarly to the example described above with respect to the first manifold and the second manifold.

In this case, the manifold unit 120 may have a hierarchical structure of the first manifold-the second manifold-the third manifold, sequentially connected from the upper level.

For another example, one or more measurement points of the apparatus 10 may be grouped based on the type of processing performed on a substrate at the measurement point.

The manifold unit 120 may further include a fourth manifold connected between the second manifold and one or more regions grouped based on the type of processing performed on a substrate. The fourth manifold may include a fourth body member, a fourth upper-level connection member, and a plurality of fourth lower-level connection members, similarly to the example described above with respect to the first manifold and the second manifold.

In this case, the manifold unit 120 may have a hierarchical structure of the first manifold—the second manifold—the fourth manifold, sequentially connected from the upper level.

The control unit 140 may control opening and closing of a plurality of valves based on a predetermined sequence. The sequence may be configured such that gas samples at one or more measurement points of the apparatus 10 may flow sequentially into the particle counter 110.

Also, when the plurality of measurement points of the apparatus 10 are grouped into a plurality of measurement groups, the sequence may be configured such that gas samples of the plurality of measurement groups may flow sequentially into the particle counter 110.

Referring to FIG. 3A, for example, the sequence may be configured such that the gas sample of the measurement point 16-1 may flow into the particle counter 110, the gas sample of the measurement point 16-2 may flow into the particle counter 110, and the gas sample of measurement point 16-3 may flow into the particle counter 110.

The control unit 140 may receive a measurement value of the particle counter 110. The control unit 140 may determine a main measurement point which needs to be monitored among the plurality of measurement points of the apparatus 10 based on the measurement value of the particle counter 110.

For example, the control unit 140 may determine a measurement point at which a rate of change of the measurement value of the particle counter 110 is a predetermined threshold value or more among the plurality of measurement points f the apparatus 10 as the main measurement point.

The control unit 140 may control opening and closing of the plurality of valves such that the gas sample of the main measurement point may flow into the particle counter 110.

For example, referring to FIG. 3A, the control unit 140 may sequentially transfer the measurement value of the particle counter 110 for the gas sample of the plurality of measurement points 16-1 to 16-3 of the apparatus 10 based on the sequence.

While the control unit 140 sequentially monitors the particle level of the plurality of measurement points 16-1 to 16-3, when the particle level of the measurement point 16-2, especially the rate of change of the measurement value of particle counter 110, is a predetermined threshold value or more, the measurement point 16-2 may be determined as the main measurement point.

The control unit 140 may stop controlling opening and closing of the valve based on the sequence, and may control opening and closing of a plurality of valves such that the gas sample of the measurement point 16-2 may flow into the particle counter 110.

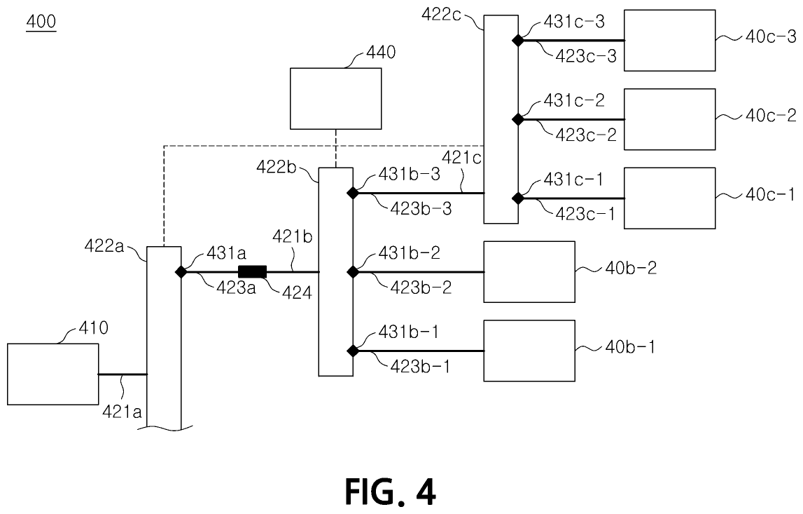

FIG. 4 illustrates one or more measurement points of a system 400 for monitoring particles and an apparatus according to another embodiment. The descriptions of the components the same as those of the system 100 for monitoring particles described with reference to FIGS. 2, 3A and 3B may not be provided.

As illustrated in FIG. 4, the system 400 for monitoring particles may include a manifold unit having a hierarchical structure divided into three levels.

The first manifold connected to the particle counter 410 may include a first body member 422a, a first upper-level connection member 421a, and a plurality of first lower-level connection members 423a. FIG. 4 illustrates only one of the plurality of first lower-level connection members 423a, and the other first lower-level connection members is not illustrated.

Gas may flow in from one or more of the plurality of first lower-level connection members 423 and may be transferred to the first upper-level connection member 421a through the first body member 422a. The gas may be transferred to the particle counter 410 through the first upper-level connection member 421a.

The system 400 for monitoring particles may further include an auxiliary apparatus 424 installed in a flow path of the manifold unit and controlling a flow rate or a velocity of the gas sample moving in the flow path.

The auxiliary apparatus 424 may be configured as, for example, an ejector, a regulator, or a fan. Alternatively, the auxiliary apparatus 424 may be configured as a flow rate sensor for measuring the flow rate in the manifold unit.

A second manifold on a lower level than the first manifold may be connected to the first manifold and may be connected to one of a plurality of first lower-level connection members 423a of the first manifold.

The second manifold may include a second body member 422b, a second upper-level connection member 421b, and a plurality of second lower-level connection members 423b-1 to 423b-3

As illustrated in FIG. 4, the second lower-level connection member 423b-1 may be connected to the measurement point 40b-1 of the apparatus, the second lower-level connection member 423b-2 may be connected to the measurement point 40b-2 of the apparatus, and the second lower-level connection member 423b-3 may be connected to the third manifold disposed on the lower level.

That is, the manifold may have a hierarchical structure in which the entirety of the plurality of lower-level connection members are connected to a measurement point of the apparatus, or the entirety of the plurality of lower-level connection members are connected to manifolds disposed on different lower levels, or a portion of the plurality of lower-level connection members is connected to a measurement point of the apparatus and the other is connected to a manifold disposed on a lower level.

The third manifold on a level lower than the second manifold may be connected to the second manifold and may be connected to one of the plurality of second lower-level connection members 423b-1 to 423b-3 of the second manifold. For example, the third manifold may be connected to the second lower-level connection member 423b-3.

The third manifold may include a third body member 422c, a third upper-level connection member 421c and a plurality of third lower-level connection members 423c-1 to 423c-3.

As illustrated in FIG. 4, each of the plurality of third lower-level connection members 423c-1 to 423c-3 may be connected to one of the different measurement points 40c-1 to 40c-3 of the apparatus.

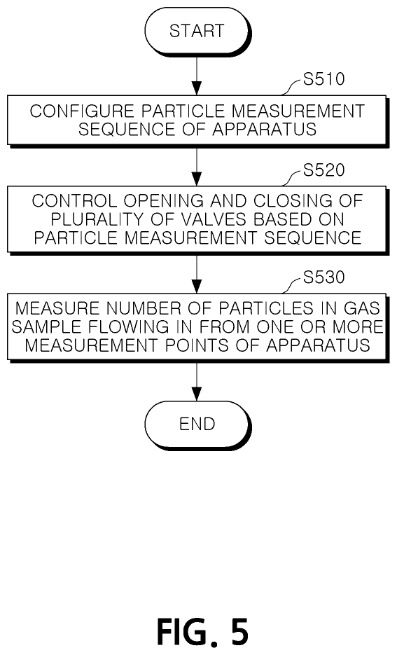

FIG. 5 is a flowchart of a method for monitoring particles according to an embodiment. The method for monitoring particles illustrated in FIG. 5 may be performed by the system for monitoring particles described with reference to FIGS. 1 to 4.

Referring to FIG. 5, the method for monitoring particles may configuring a particle measurement sequence of the apparatus (S510), controlling opening and closing of a plurality of valves based on the particle measurement sequence (S520), and measuring the number of particles in a gas sample flowing in from one or more measurement points of the apparatus (S530).

The configuring a particle measurement sequence (S510) may include configuring a first sequence such that gas samples of the plurality of measurement points of the apparatus sequentially may flow into a particle counter.

The method for monitoring particles may further include determining a main measurement point among the plurality of measurement points based on the number of particles in the measured gas sample, and controlling opening and closing of the plurality of valves such that gas samples of the main measurement point may flow into the particle counter.

In the determining the main measurement point, a measurement point at which a rate of change of the measurement value of the particle counter is a predetermined threshold value or more among the plurality of measurement points of the apparatus may be determined as the main measurement point.

The configuring a particle measurement sequence (S510) may further include grouping the plurality of measurement points into one or more measurement groups and configuring a second sequence such that gas samples of the one or more measurement groups may sequentially flow into the particle counter.

In the grouping the plurality of measurement points into one or more measurement groups, the plurality of measurement points of the apparatus may be grouped into one or more measurement groups based on the degree of proximity to each other or the type of processing performed on a substrate.

The configuring a particle measurement sequence (S510) may further include configuring a third sequence such that gas samples at the measurement points included in the one or more measurement groups may sequentially flow into the particle counter.

The method for monitoring particles may further include executing a third sequence based on the number of particles in a gas sample of one or more measurement groups measured based on the second sequence.

That is, the method for monitoring particles according to an embodiment may monitor the number of particles for each measurement group based on the second sequence, and may execute a third sequence to sequentially monitor gas samples at the measurement points included in a specific measurement group.

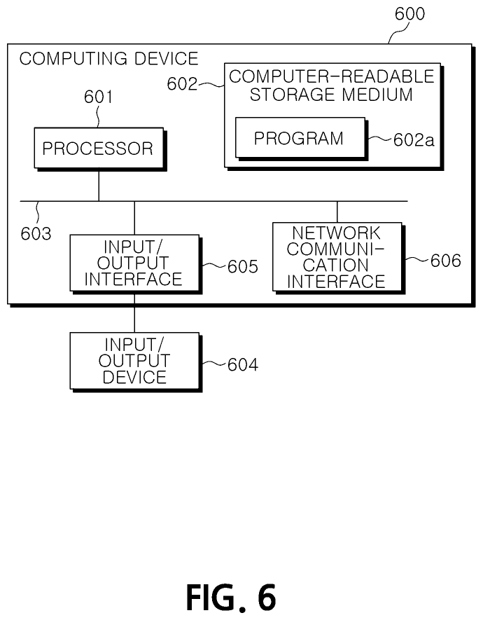

FIG. 6 is a block diagram illustrating a computing device 600 in which the method for monitoring particles according to an embodiment may be entirely or partially implemented, illustrating a control unit of a system for monitoring particles which may perform the method for monitoring particles described through FIGS. 1 to 5.

As illustrated in FIG. 6, a computing device 600 may include at least one processor 601, a computer-readable storage medium 602, and a communication bus 603.

The processor 601 may allow the computing device 600 to operate according to an embodiment described above. For example, the processor 601 may execute one or more programs stored on the computer-readable storage medium 602. The one or more programs may include one or more computer-executable instructions, and when the computer-executable instructions are executed by the processor 601, the computer-executable instructions may be configured to allow the computing device 600 to perform operations according to an embodiment.

The computer-readable storage medium 602 may be configured to store computer-executable instructions to a program code, a program data, and/or other suitable forms of information. A program 602a stored in the computer-readable storage medium 602 may include a set of instructions executable by the processor 601. In an embodiment, the computer-readable storage medium 602 may be implemented as a memory (a volatile memory such as random access memory, nonvolatile memory, or a suitable combination thereof), one or more magnetic disk storage devices, optical disk storage devices, flash memory devices, or any other form of storage medium accessed by the computing device 600 and storing desired information, or a suitable combination thereof.

The communication bus 603 may interconnect various other components of the computing device 600, including the processor 601, and the computer-readable storage medium 602.

The computing device 600 may also include one or more input/output interfaces 605 and one or more network communication interfaces 606 providing an interface for one or more input/output devices 604. The input/output interface 605 and the network communication interface 606 may be connected to the communication bus 603.

The input/output device 604 may be connected to other components of the computing device 600 through the input/output interface 605. The exemplary input/output device 604 may include input devices such as a pointing device (mouse or trackpad, or the like), a keyboard, a touch input device (touchpad or touchscreen, or the like), a voice or sound input device, various types of sensor devices, and/or a photographing device, and/or output devices such as a display device, a printer, a speaker, and/or a network card. The exemplary input/output device 604 may be included in the computing device 600 as a component included in the computing device 600, or may be connected to the computing device 600 as a device distinct from the computing device 600.

In an embodiment, a program for performing the methods described in the embodiments on a computer, and a computer-readable recording medium including the program may be included. The computer-readable recording medium may include program commands, local data files, local data structures, or the like, alone or in combination. The medium may be specially designed and configured for an embodiment, or may be commonly used in the computer software field. Examples of the computer-readable recording medium may include magnetic media such as a hard disk, floppy disk, and magnetic tape, optical recording media such as CD-ROM and DVD, and a hardware device specially configured to store and perform program commands such as ROM, RAM, and flash memory. Examples of the program may include machine language codes generated by a compiler, and also high-level language codes executed by a computer using an interpreter, or the like.

According to the aforementioned embodiments, a system and a method for monitoring particles of an apparatus, which may monitor particle levels of a plurality of measurement points of an apparatus may be provided.

Also, a system and a method for monitoring particles of an apparatus, which may obtain a gas sample at a desired measurement point by controlling a plurality of manifolds having a hierarchical structure and opening and closing of a plurality of valves installed in different positions in the manifolds may be provided.

Also, a system and a method for monitoring particles of an apparatus, which may control opening and closing of a plurality of valves based on a predetermined sequence such that gas samples of a plurality of measurement points may flow in sequentially, or such that gas samples of a specific portion of the plurality of measurement points may flow in may be provided.

While the embodiments have been illustrated and described above, it will be configured as apparent to those skilled in the art that modifications and variations could be made without departing from the scope of the present disclosure as defined by the appended claims.

What is claimed is:

1. A system for monitoring particles of an apparatus, the system comprising:
a particle counter configured to measure the number of particles in a gas sample obtained from an apparatus;
a manifold unit configured to provide a flow path for the gas sample to move from the apparatus to the particle counter;
a valve unit including a plurality of valves installed in different positions in the manifold unit; and
a control unit configured to control opening and closing of the plurality of valves,
wherein the manifold unit includes a plurality of manifolds having a hierarchical structure and installed between the particle counter and a plurality of measurement points of the apparatus.

2. The system of claim 1,
wherein the plurality of the manifold includes:
a body member;
an upper-level connection member extending from the body member in a direction toward the particle counter; and
a plurality of lower-level connection members extending from the body member in a direction toward the apparatus or the plurality of measurement points, and
wherein the body member provides a moving space through which gas flowing in from the plurality of lower-level connection members moves to the upper-level connection member.

3. The system of claim 2,
wherein the apparatus is divided into a plurality of levels including one or more measurement points, and
wherein the manifold unit includes:
a first manifold connected between the particle counter and the plurality of levels; and
a second manifold connected between the first manifold and the one or more measurement points.

4. The system of claim 3,
wherein the one or more measurement points are grouped into one or more regions based on a degree of proximity to each other, and
wherein the manifold unit further includes a third manifold connected between the second manifold and the one or more regions.

5. The system of claim 3,
wherein the one or more measurement points are grouped into one or more regions based on a type of processing performed on a substrate, and
wherein the manifold unit further includes a fourth manifold connected between the second manifold and the one or more regions.

6. The system of claim 2, wherein the plurality of valves are installed on the upper-level connection member or the plurality of lower-level connection members.

7. The system of claim 6,
wherein the apparatus includes a plurality of measurement points in different positions,
wherein the control unit controls opening and closing of the plurality of valves based on a predetermined sequence, and
wherein the sequence is configured such that gas samples at the plurality of measurement points flow sequentially into the particle counter.

8. The system of claim 7, wherein the control unit determines a main measurement point which needs to be monitored among the plurality of measurement points based on a measurement value of the particle counter, and controls opening and closing of the plurality of valves such that a gas sample at the main measurement point flows into the particle counter.

9. The system of claim 8, wherein the control unit determines a measurement point at which a rate of change of a measurement value of the particle counter is a predetermined threshold value or more among the plurality of measurement points as the main measurement point.

10. The system of claim 6,
wherein the apparatus includes a plurality of measurement points in different positions,
wherein the control unit controls opening and closing of the plurality of valves based on a predetermined sequence,
wherein the plurality of: measurement points are grouped into a plurality of measurement groups, and
wherein the sequence is configured such that gas samples of the plurality of measurement groups flow sequentially into the particle counter.

11. The system of claim 1, wherein the manifold unit further includes an auxiliary apparatus installed in the flow path and configured to control a flow rate or a velocity of the gas sample moving in the flow path.

12. A method for monitoring particles of an apparatus, the method comprising:
configuring a particle measurement sequence of an apparatus;
controlling opening and closing of a plurality of valves based on the particle measurement sequence; and
measuring the number of particles in a gas sample flowing in from one or more measurement points of the apparatus,
wherein the plurality of valves are installed in different positions in a manifold unit configured to provide a flow path for the gas sample to move from the apparatus to a particle counter configured to measure the number of particles, and
wherein the manifold unit includes a plurality of manifolds having a hierarchical structure and installed between the particle counter and a plurality of measurement points of the apparatus.

13. The method of claim 12,
wherein the apparatus includes a plurality of measurement points in different positions, and
wherein the configuring a particle measurement sequence of the apparatus includes configuring a first sequence such that gas samples at a plurality of measurement points flow sequentially into the particle counter.

14. The method of claim 13, further comprising:
determining a main measurement point among the plurality of measurement points based on the number of particles in the measured gas sample; and
controlling opening and closing of the plurality of valves such that a gas sample at the main measurement point flows into the particle counter.

15. The method of claim 14, wherein the determining a main measurement point includes determining a measurement point at which a rate of change of a measurement value of the particle counter is a predetermined threshold value or more among a plurality of measurement points as the main measurement point.

16. The method of claim 12,
wherein the apparatus includes a plurality of measurement points in different positions, and
wherein the configuring a particle measurement sequence of the apparatus includes:
grouping a plurality of measurement points into one or more measurement groups; and
configuring a second sequence such that gas samples of the one or more measurement groups flow sequentially into the particle counter.

17. The method of claim 16, wherein the grouping into one or more measurement groups includes grouping the plurality of measurement points into one or more measurement groups based on a degree of proximity to each other or a type of processing performed on a substrate.

18. The method of claim 16, wherein the configuring a particle measurement sequence of the apparatus further includes:
configuring a third sequence such that gas samples at measurement points included in the one or more measurement groups flow sequentially into the particle counter; and
executing the third sequence based on the number of particles in gas samples of the one or more measurement groups measured based on the second sequence.

19. A system for monitoring particles of an apparatus, the system comprising:
a particle counter configured to measure the number of particles in a gas sample obtained from the apparatus;
a manifold unit configured to provide a flow path for the gas sample to move from the apparatus to the particle counter;
a valve unit including a plurality of valves installed in different positions in the manifold unit;
a flow rate sensor configured to measure a flow rate in the manifold unit; and
a control unit configured to individually control opening and closing of the plurality of valves,
wherein the apparatus is divided into a plurality of levels including one or more measurement points, and
wherein the manifold unit includes:
an upper manifold connecting the particle counter to the apparatus; and
a lower manifold installed on one of the plurality of levels and connecting the upper manifold to one or more measurement points positioned in the one of the levels,
wherein the valve unit includes:
a plurality of first valves installed on the upper manifold; and
a plurality of second valves installed on the lower manifold.

20. The system of claim 19,
wherein the control unit controls opening and closing of the plurality of valves based on a predetermined sequence, and
wherein the sequence is configured such that gas samples on the plurality of levels sequentially flow into the particle counter.
